(19) United States
(12) Patent Application Publication
(10) Pub. No.: US 2010/0103463 A1
(43) Pub. Date: Apr. 29, 2010

(54) DETERMINING GEOGRAPHIC LOCATION OF A SCANNED IMAGE

(76) Inventors: Dhiraj Joshi, Rochester, NY (US); Jie Yu, Rochester, NY (US); Andrew C. Gallagher, Fairport, NY (US)

Correspondence Address: J. Lanny Tucker;Patent Legal Staff, Eastman Kodak Company, 343 State Street, Rochester, NY, 14650-2201, US

(21) Appl. No.: 12/259,331

(22) Filed: Oct. 28, 2008

(51) Int. Cl. G06K 9/00; G06K 15/00

(52) U.S. Cl. 358/1.16; 382/181

(57) ABSTRACT

A method of determining the geographic location of a hardcopy medium having an image side and a non-image side, includes scanning a hardcopy medium to produce a scanned digital image; scanning the non-image side of the hardcopy medium; detecting a location feature from the scan of the non-image side of the hardcopy medium; using the location feature to determine the geographic location of the scanned digital image; and storing the determined geographic location of the scanned digital image.

### CROSS REFERENCE TO RELATED APPLICATIONS

Reference is made to commonly assigned U.S. patent application Ser. No. 11/511,798 file Apr. 21, 2006 (now U.S. Patent Application Publication No. 2007/0250529) entitled “Method for Automatically Generating a Dynamic Digital Metadata Record From Digitized Hardcopy Media by Louis J. Beato et al; U.S. patent application Ser. No. 12/136,820 field Jun. 11, 2008, entitled “Finding Image Capture Date of Hardcopy Medium” by Andrew C. Gallagher et al and U.S. patent application Ser. No. 12/136,836 filed Jun. 11, 2008, entitled “Finding Orientation and Date of Hardcopy Medium” by Andrew C. Gallagher et al, the disclosures of which are incorporated herein.

### FIELD OF THE INVENTION

The present invention is related to determining the geographic location of a scanned digital image.

### BACKGROUND OF THE INVENTION

Consumers today are switching from film-based chemical photography to digital photography in increasing numbers. The instantaneous nature of image capture and review, the ease of use, numerous output and sharing options, multimedium capabilities, and on-line and digital medium storage capabilities have all contributed to consumer acceptance of this technological advancement. A hard drive, on-line account, or a DVD can store thousands of images, which are readily available for printing, transmitting, conversion to another format, conversion to another medium, or used to produce an image product. Since the popularity of digital photography is relatively new, the majority of images retained by a typical consumer usually takes the form of hardcopy medium. These legacy images can span decades of time and have a great deal of personal and emotional importance to the collection's owner. In fact, these images often increase in value to their owners over time. Thus, even images that were once not deemed good enough for display are now cherished. These images are often stored in boxes, albums, frames, or even their original photofinishing return envelopes.

Getting a large collection of legacy images into a digital form is often a formidable task for a typical consumer. The user is required to sort through hundreds of physical prints and place them in some relevant order, such as chronology or sorting by event. Typically, events are contained on the same roll of film or across several rolls of film processed in the same relative time frame. After sorting the prints, the user would be required to scan the medium to make a digital version of the image. Scanning hardcopy image medium such as photographic prints to obtain a digital record is well known. Many solutions currently exist to perform this function and are available at retail from imaging kiosks and digital minilabs and at home with “all-in-one” scanner/printers or with personal computers equipped with medium scanners. Some medium scanning devices include medium transport structure, simplifying the task of scanning hardcopy medium. Using any of these systems requires that the user spend time or expense converting the images into a digital form only to be left with the problem of providing some sort of organizational structure to the collection of digital files generated.

The prior art teaches sorting scanned hardcopy images by physical characteristics and also utilizing information/annotation from the front and back of the image. This teaching permits grouping images in a specific chronological sequence, which can be adequate for very large image collections.

Hardcopy images exist from many areas of the world. It is desirable to identify the geographic location of a given image as this information assists in searching and organizing an image collection (e.g. an image collection viewer can view all images captured in Canada, or all images from California in the years 1950-1960). Current methods for identifying geographic location from an image (e.g. J. Hays, A. Efros, “IM2GPS: estimating geographic information from a single image”. Proceedings of the IEEE Conf. on Computer Vision and Pattern Recognition (CVPR), 2008) rely solely on the information in a digital image but ignore valuable features such as watermarks, postage stamps, language, annotation, and date format. Therefore, current methods are not adequate for accurately determining a geolocation for a hardcopy image.

### SUMMARY OF THE INVENTION

The present invention provides a method of determining the geographic location of a hardcopy medium having an image side and a non-image side, comprising:

(a) scanning a hardcopy medium to produce a scanned digital image;

(b) scanning the non-image side of the hardcopy medium;

(c) detecting a location feature from the scan of the non-image side of the hardcopy medium;

(d) using the location feature to determine the geographic location of the scanned digital image; and

(e) storing the determined geographic location of the scanned digital image.

### BRIEF DESCRIPTION OF THE DRAWINGS

The invention can be more completely understood by considering the detailed description of various embodiments of the invention which follows in connection with the accompanying drawings. Referring now to the drawings in which like reference numbers represent corresponding parts throughout:

FIG. 1 is an illustration of a system that sorts hardcopy medium images using the physical characteristics obtained from the image bearing hardcopy medium;

FIG. 2 is an illustration of other types of hardcopy medium collections such as photo books, archive CDs and online photo albums;

FIG. 3A is an illustration of an image and a non-image surface of a hardcopy medium image including a watermark on the non-image surface and the date of image processing on the image surface;

FIG. 3B is an illustration of an image and a non-image surface of a hardcopy medium image including a watermark and handwritten text on the non-image surface, and the date of image processing on the image surface;

FIG. 3C is an illustration of an image and a non-image surface of a hardcopy medium image including printed text, stamp, and postmark label on the non-image surface, and the date of image processing on the image surface;

FIG. 3D is an illustration of an image and a non-image surface of a hardcopy medium image including a watermark, printed text, stamp, and postmark label on the non-image surface, and the date of image processing on the image surface;

FIG. 3E is an illustration of an image and a non-image surface of a hardcopy medium image including a watermark, printed text, handwritten text, stamp, and postmark label on the non-image surface, and the date of image processing on the image surface;

FIG. 3F is an illustration of an image and a non-image surface of a hardcopy medium image including a watermark, printed text, handwritten text, stamp, and postmark label on the non-image surface, and the date of image processing and handwritten text on the image surface;

FIG. 3G is an illustration of the process of information extraction from an image and non-image surface of a hardcopy medium image including a watermark, printed text, handwritten text, stamp, and postmark label on the non-image surface, and the date of image processing and handwritten text on the image surface;

FIG. 4 is an illustration of recorded metadata dynamically extracted from the surfaces of a hardcopy medium image;

FIG. 5 is an illustration of metadata dynamically derived from the combination of image and non-image surfaces and recorded metadata of a hardcopy medium;

FIG. 6 is an illustration of sample values for dynamically derived metadata;

FIG. 7 is an illustration of the combination of the recorded metadata and the derived metadata that results in the complete metadata representation;

FIGS. 8A and 8B are flow charts illustrating the sequence of operation for creating the recorded, derived, and complete metadata representations;

FIG. 9 shows a flow chart that illustrates the automatic creation of metadata associated with the geographic locations of images from a scanned image collection;

FIG. 10A is an illustration of a beach on the image surface of a hardcopy medium image;

FIG. 10B is an illustration of handwritten text on the non-image surface of a hardcopy medium with the corresponding image-surface illustrated in FIG. 10A;

FIG. 10C is an illustration of a baseball game on the image surface of a hardcopy medium image;

FIG. 10D is an illustration of handwritten text on the non-image surface of a hardcopy medium with the corresponding image-surface illustrated in FIG. 10C;

FIG. 10E is an illustration of Eiffel tower on the image surface of a hardcopy medium image;

FIG. 10F is an illustration of handwritten text on the non-image surface of a hardcopy medium with the corresponding image-surface illustrated in FIG. 10E; and

FIG. 11 shows a flow chart that illustrates the automatic creation of groups of images from a scanned image collection and creation of metadata associated with the geographic locations of groups of images.

### DETAILED DESCRIPTION OF THE INVENTION

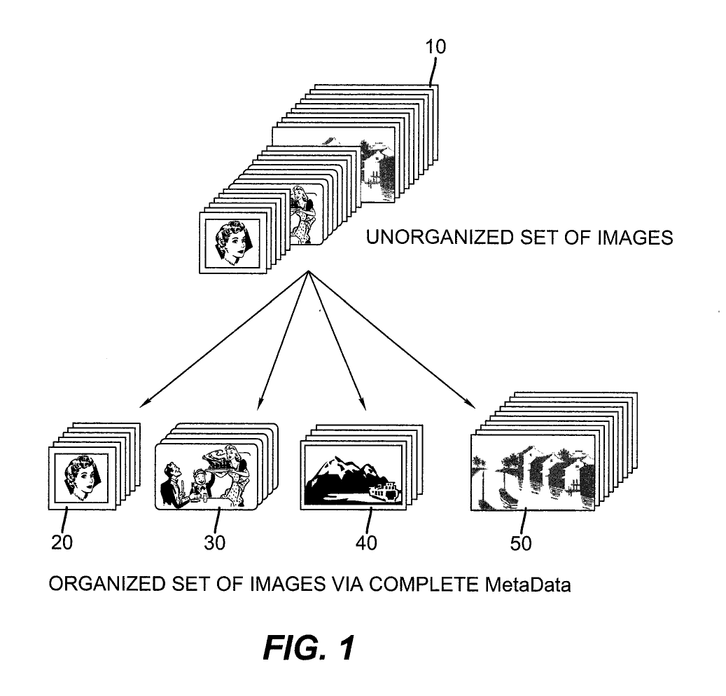

FIG. 1 illustrates one technique to sort hardcopy medium images using the physical characteristics obtained from the image bearing hardcopy medium. Hardcopy medium collections include, for example, optically and digitally exposed photographic prints, thermal prints, electro-photographic prints, inkjet prints, slides, film motion captures, and negatives. These hardcopy medium often correspond with images captured with image capture devices such as cameras, sensors, or scanners. Over time, hardcopy medium collections grow and medium of various forms and formats are added to various consumer selected storage techniques such as boxes, albums, file cabinets, and the like. Some users keep the photographic prints, index prints, and film negatives from individual rolls of film in their original photofinishing print return envelopes. Other users remove the prints and they become separated from index prints and film negatives and become combined with prints from other rolls.

Over time, these collections become large and unwieldy. Users typically store these collections in boxes and it is difficult to find and gather images from certain events or time erase. It can require a significant time investment for the user to locate their images given the sorting requirement they can have at that time. For example, if you were looking for all images of your children, it would be extremely difficult to manually search your collection and look at each image to determine if it includes your child. If you are looking for images from the 1970s, you would have a very difficult process once again to look at the image (either the front or the back) to find the year it was taken.

These unorganized collections of hardcopy medium 10 also includes of print medium of various sizes and formats. This unorganized hardcopy medium 10 can be converted to digital form with a medium scanner capable of duplex scanning (not shown). If the hardcopy medium 10 is provided in a “loose form,” such as with prints in a shoebox, it is preferable to use a scanner with an automatic print feed and drive system. If the hardcopy medium 10 is provided in albums or in frames, a page scanner or digital copy stand should be used so as not to disturb or potentially damage the hardcopy medium 10.

Once digitized, the resulting digitized images are separated into designated subgroups 20, 30, 40, 50 based on physical size and format determined from the image data recorded by the scanner. Existing medium scanners, such as the KODAK i600 Series Document Scanners, automatically transport and duplex scan hardcopy medium, and include image-processing software to provide automatic de-skewing, cropping, correction, text detection, and Optical Character Recognition (OCR). The first subgroup 20 represents images of bordered 3.5″×3.5″ (8.89 cm×8.89 cm) prints. The second subgroup 30 represents images of borderless 3.5″×5″ (8.89 cm×12.7 cm) prints with round corners. The third subgroup 40 represents images of bordered 3.5″×0.5″ (8.89 cm×12.7 cm) prints. The fourth subgroup 50 represents images of borderless 4″×6″ (10.16 cm×15.24 cm) prints. Even with this new organizational structure, any customer provided grouping or sequence of images is maintained as a sort criterion. Each group, whether envelope, pile or box, should be scanned and tagged as a member of “as received” group and sequence within the group should be recorded.

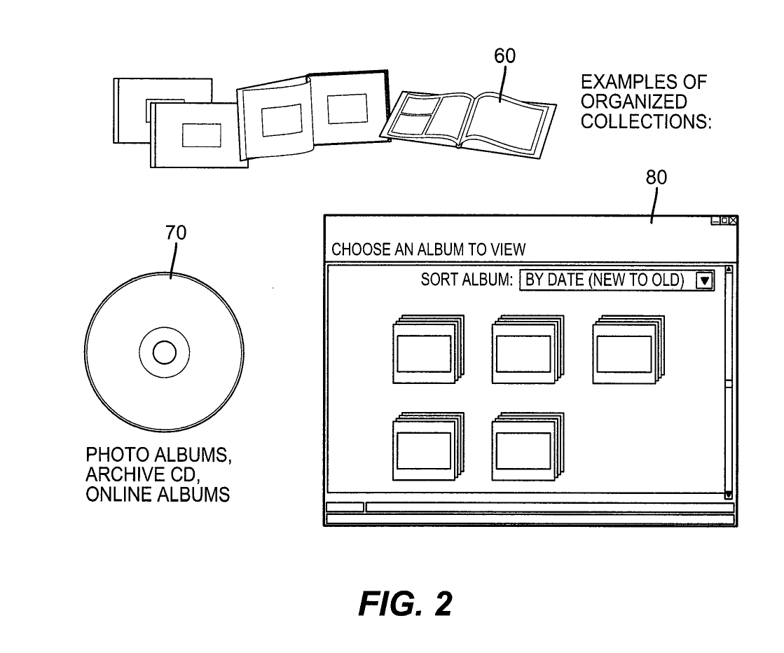

FIG. 2 illustrates other types of hardcopy medium collections such as photo books, archive CDs and online photo albums. A picture book 60 contains hardcopy medium printed using various layouts selected by the user. The layouts can be by date, or event. Another type of hardcopy medium collection is the Picture CD 70 having images stored on the CD in various formats. These images could be sorted by date, event, or any other criteria that the user can apply. Another type of hardcopy medium collection is an online gallery of images 80, which is typically stored in an online (Internet based) or offline (local storage). All of the collections in FIG. 2 are similar, but the storage mechanism is different. For example, the picture book 60 includes a printed page(s), the Picture CD 70 stored information on a CD, and the online gallery of images 80 is stored in magnetic storage.

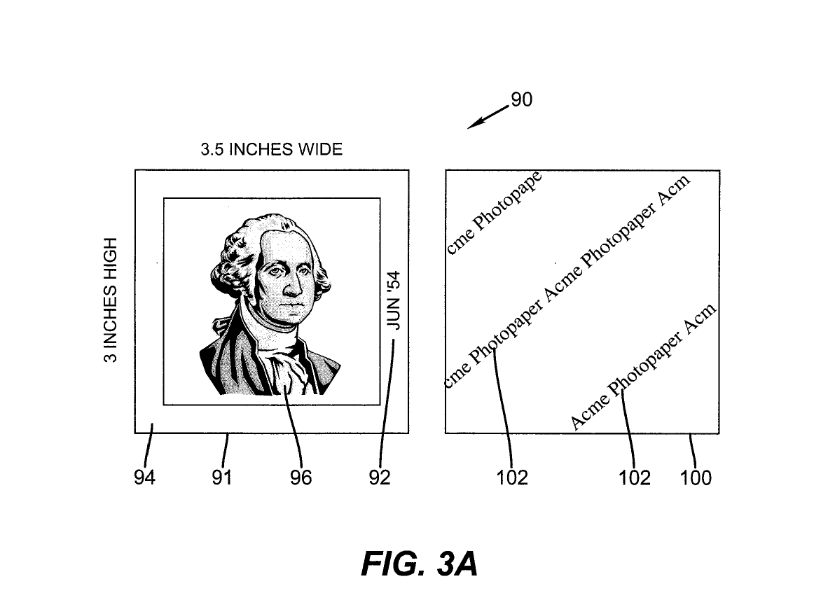

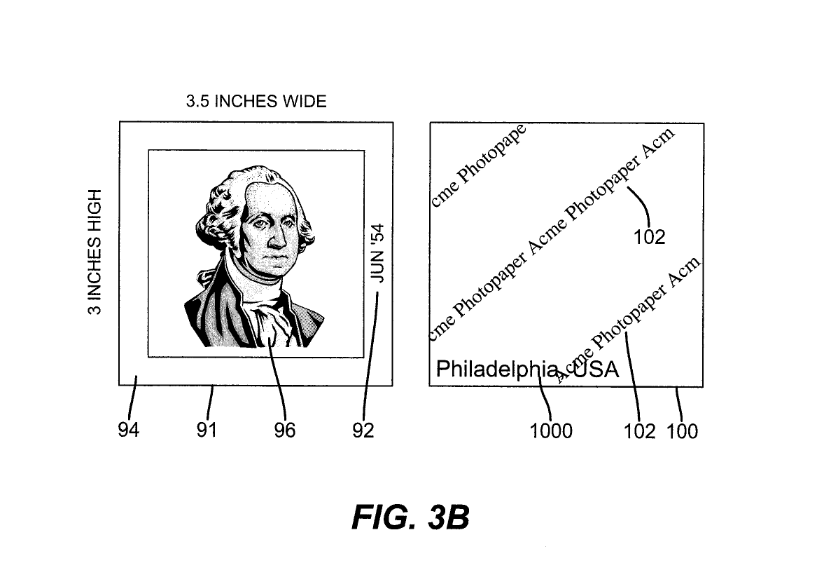

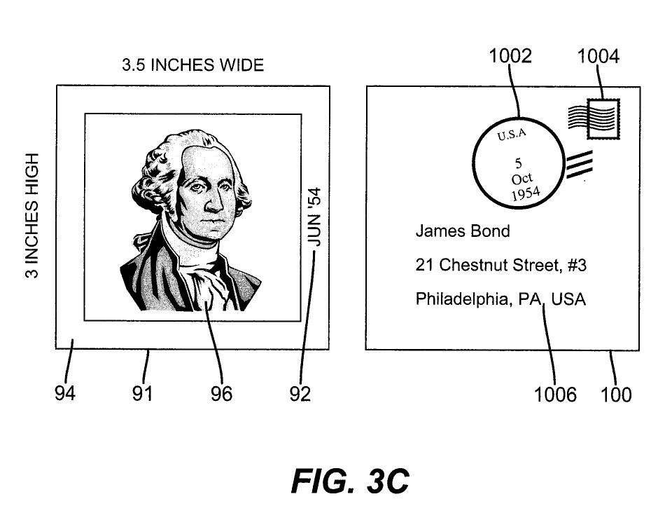

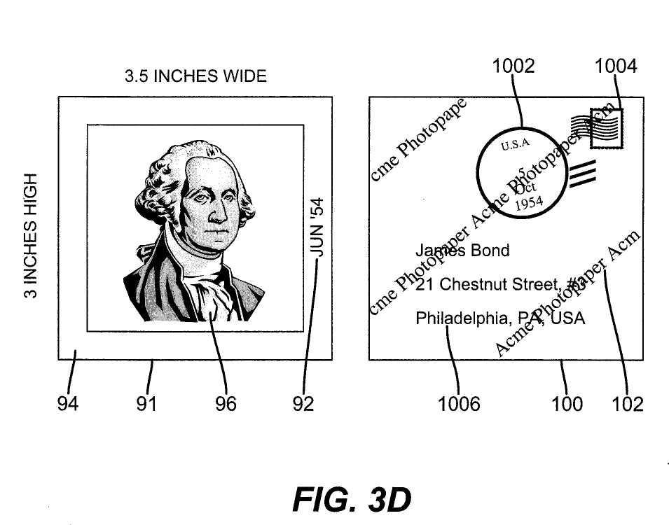

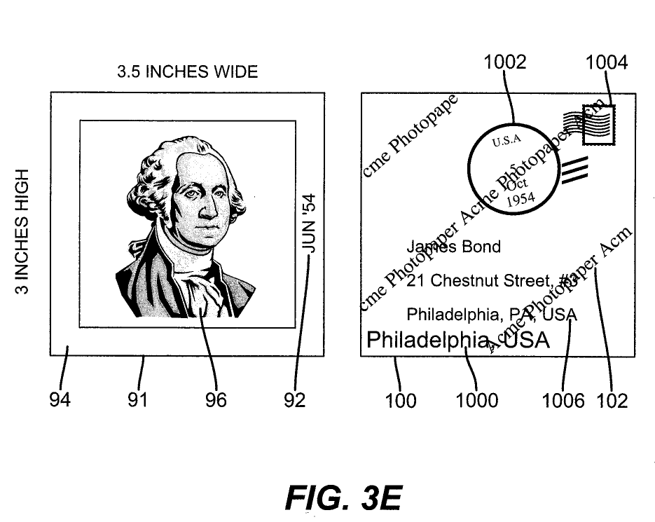

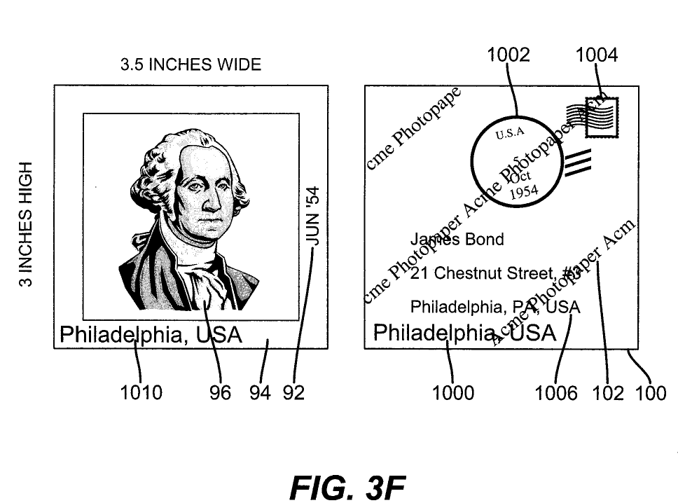

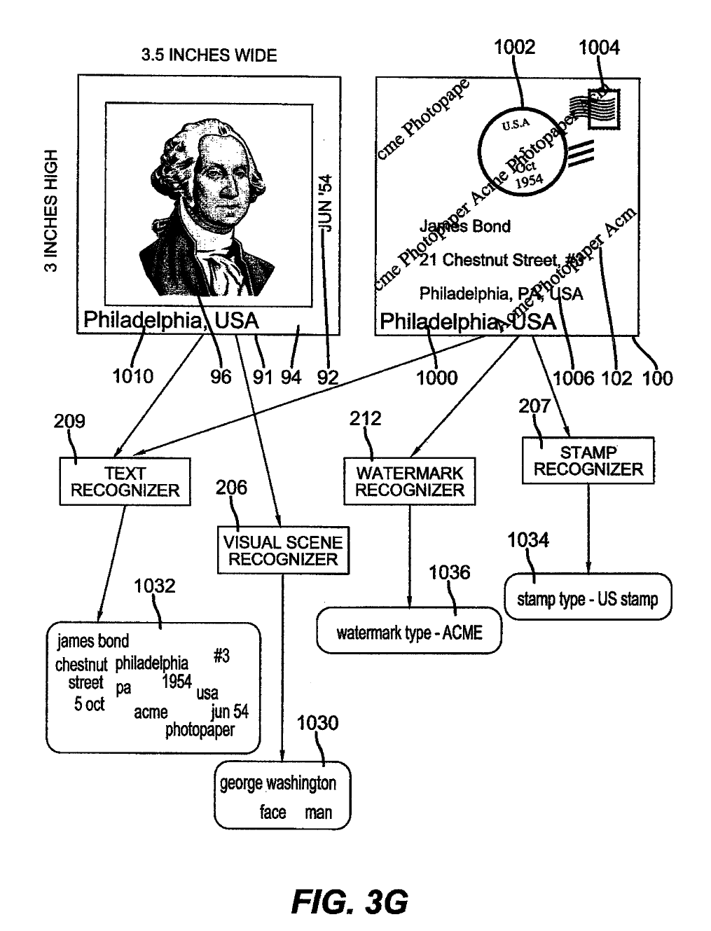

FIGS. 3A-3G illustrate examples of a hardcopy imaging medium that include both the image and non-image surfaces. In FIG. 3A, photographic print medium 90 contains information that can be instantly recorded (e.g., size, or aspect ratio) and information that can be derived (e.g. black-white versus color, or border). Together this information can be gathered as metadata for the print medium 90 and stored along with the print medium 90. This metadata contains intrinsic information about the print medium 90 that can be formed into a type of organizational structure, such as a dynamic digital metadata record, to be used by the user to locate a specific event, time era, or group of prints that meet some criteria. For example, a user may want to collect all of the users' prints from the 1960s and 1970s so as to apply a dye fade reversal process to restore the prints. The user could want all pictures of your wedding or some other special occasion. If the prints contain this metadata in a digital form, the information can be used for these purposes.

This dynamic digital metadata record is an organizational structure that becomes even more important as image collections grow in size and time frame. If the hardcopy image collection is large, including thousands of images, and is converted to digital form, an organizational structure such as a file structure, searchable database, or navigational interface is required in order to establish usefulness.

Photographic print medium 90 and the like have an image surface 91, a non-image surface 100, and often include a manufacturer's watermark 102 on the non-imaging surface 100 of the print medium 90. The manufacturer of the print medium 90 prints watermarks 102 on “master rolls” of medium, which are slit or cut into smaller rolls suitable for use in photo processing equipment such as kiosks, minilabs, and digital printers. Manufacturers change watermarks 102 from time to time as new medium types with new characteristics, features and brand designations are introduced to the market. Watermarks 102 are used for promotional activities such as advertising manufacturer sponsorships, to designate special photofinishing processes and services, and to incorporate market specific characteristics such as foreign language translations for sale in foreign markets. Watermarks 102 are typically non-photographically printed on the non-image surface 100 of the print medium 90 with a subdued density and can include text of various fonts, graphics, logos, color variations, multiple colors, and typically run diagonally to the medium roll and cut print shape.

Manufacturers also include slight variations to the master roll watermarks such as adding a line above or below a designated character in the case of an alphanumeric watermark. This coding technique is not obvious or even apparent to user, but is used by the manufacturer in order to monitor manufacturing process control or to identify the location of a manufacturing process problem if a defect is detected. Different variations are printed at set locations across the master medium roll. When finished rolls are cut from the master roll they retain the specific coded watermark variant applied at that relative position along the master roll. In addition, manufacturers maintain records of the various watermark styles, coding methodologies, and when specific watermark styles were introduced into the market.

In testing with actual consumer hardcopy medium, it has been determined that watermark variations, including manufacturer watermarks with special process control coding, provided a very effective way to determine original film roll printing groupings. Once hardcopy medium images are separated into original roll printing groups, image analysis techniques can be used to further separate the roll groupings into individual events. Watermark analysis can also be used to determine printing sequence, printing image orientation, and the time frame in which the print was generated.

A typical photofinishing order, such as processing and printing a roll of film, will, under most circumstances, be printed on medium from the same finished medium roll. If a medium roll contains a watermark with a manufacturer's variant code and is used to print a roll of film negatives, the resulting prints will have a watermark that will most likely be unique within a user's hardcopy medium collection. An exception to this can be if a user had several rolls of film printed at the same time by the same photofinisher, as with film processed at the end of an extended vacation or significant event. However, even if the photofinisher had to begin a new roll of print paper during printing a particular customer's order, it is likely that the new roll will be from the same batch as the first. Even if that is not the case, the grouping of the event such as a vacation into two groups on the basis of differing back prints is not catastrophic.

The medium manufacturer, on an ongoing basis, releases new medium types with unique watermarks 102 to the market. Digital image scanning systems (not shown) can convert these watermarks 102 into digital records, which can be analyzed using Optical Character Recognition (OCR) or digital pattern matching techniques. This analysis is directed at identifying the watermark 102 so that the digital record can be compared to the contents of Look Up Tables (LUT's ) provided by a manufacturer of the medium. Once identified, the scanned watermark 102 can be used to provide a date of manufacture or sale of the print medium. This date can be stored in the dynamic digital metadata record. The image obtained from the image surface 91 of the hardcopy medium 90 is sometimes provided with a date designation 92 such as the markings from a camera date back, which can be used to establish a time frame for a scanned hardcopy medium image 96 without intervention from the user.

If the hardcopy medium 90 has an unrecognized watermark style, that watermark pattern is recorded and stored as metadata in the dynamic digital metadata record and later used for sorting purposes. If a photofinisher or user applied date or other information indicative of an event, time frame, location, subject identification, or the like is detected, that information would be incorporated into the LUT and used to establish a chronology or other organizational structure for subsequent images including the previously unidentified watermark. If a user or photofinisher applied date is observed on that hardcopy medium 90, that date can be added to the LUT. The automatically updated LUT can now use this new associated date whenever this unknown watermark style is encountered. This technique can be deployed to establish a relative chronology for hardcopy image collections that can span decades.

Another technique uses the physical format characteristics of hardcopy medium 90 and correlates these to the film systems that were used to create them and the time frames that these film systems were in general use. Examples of these formats and related characteristics include the INSTAMATIC (a trademark of the Eastman Kodak Company) Camera and 126 film cartridge introduced in 1963 which produced 3.5 inch×3.5 inch (8.89 cm×8.89 cm) prints and was available in roll sizes of 12, 20, and 24 frames.

The Kodak Instamatic camera 110 film cartridge was introduced in 1972 and produced 3.5″×5″ (8.89 cm×12.7 cm) prints and was available in roll sizes: 12, 20, and, 24 frames. The Kodak Disc camera and Kodak Disc film cartridge was introduced in 1982 and produced 3.5″×4.5″ (8.89 cm×11.43 cm) prints with 15 images per Disc. Kodak, Fuji, Canon, Minolta and Nikon introduced the Advanced Photo System (APS) in 1996. The camera and film system had the capability for user selectable multiple formats including Classic, HDTV, and Pan producing prints sizes of 4″×6″, 4″×7″, and 4″×11″ (10.16 cm ×15.24 cm, 10.16×17.78 cm, 10.16×27.94 cm). Film roll sizes were available in 15, 25, and 40 frames and index prints containing imagettes of all images recorded on the film were a standard feature of the system.

The APS system has a date exchange system permitting the manufacturer, camera, and photofinishing system to record information on a clear magnetic layer coated on the film. An example of this data exchange was that the camera could record the time of exposure and the user selected format on the film's magnetic layer which was read and used by the photofinishing system to produce the print in the desired format and record the time of exposure, frame number, and film roll ID# on the back of the print and on the front surface of a digitally printed index print. 35 mm photography has been available in various forms since the 1920's to present and has maintained popularity until the present in the form of “One Time Use Cameras.” 35 mm systems typically produce 3.5″ (8.89 cm)×5″ (12.7 cm) or 4″ (10.16 cm)×6″ (15.24 cm). Prints and roll sizes are available in 12, 24 and 36 frame sizes. “One Time Use Cameras” has the unique characteristic in that the film is “reverse wound” meaning that the film is wound back into the film cassette as pictures are taken producing a print sequence opposite to the normal sequence. Characteristics such as physical format, expected frame count, and imaging system time frame can all be used to organize scanning hardcopy medium into meaningful events, time frames, and sequences.

As with traditional photography instant photography systems also changed over time, for example, the Instant film SX-70 format was introduced in the 1970s, the Spectra system, Captiva, I-Zone systems were introduced in the 1990s, each of which had a unique print size, shape, and border configuration.

For cameras with a square format, the photographer had little incentive to rotate the camera. However, for image capture devices that produce rectangular hardcopy prints, the photographer sometimes rotates the image capture device by 90 degrees about the optical axis to capture a portrait format image (i.e. the image to be captured has a height greater than its width to capture objects such a buildings that are taller than they are wide) rather than a landscape format image (i.e. the image to be captured has a width greater than it's height).

In FIG. 3A, some of the above mentioned characteristics are shown. Image surface 91 of the hardcopy imaging medium 90 is illustrated. The image surface 91 indicates the date designation 92 printed in a border 94. Centered on the image surface 91 is actual image data 96 of the hardcopy medium 90. In one embodiment, the non-image surface 100 includes a common configuration representing a watermark 102. In this embodiment, lines of evenly spaced text or graphics run diagonally across the back surface of hardcopy imaging medium, representing the watermark 102. In the embodiment, the watermark 102 includes a repeating text “Acme Photopaper.”

FIG. 3B contains all the features of FIG. 3A and additionally contains handwritten text 1000 on the non-image surface 100. In this embodiment, the handwritten text 1000 is “Philadelphia, USA”. In the past, photographs were often mailed to people as postcards. It is not uncommon to find postage stamps, postmark labels, and addresses on the non-image surface of a scanned photograph. In FIG. 3C, the non-image surface 100 contains a postage stamp 1004, a postmark label 1002, and an address 1006. In this particular embodiment, the postmark label 1002 includes the text “USA, 5 Oct. 1954” and the address 1006 includes the text “James Bond 21 Chestnut Street #3 Philadelphia Pa. USA”. In addition to the features contained in FIG. 3C, FIG. 3D contains the watermark 102 on the non-image surface 100. In the embodiment shown, the watermark 102 includes a repeating text “Acme Photopaper”. In addition to features contained in FIG. 3D, FIG. 3E contains handwritten text 1000 on the non-image surface 100. In addition to features contained in FIG. 3E, FIG. 3F contains handwritten text 1010 on the image surface 91 as well. In this embodiment, the handwritten text 1000 and the handwritten text 1010 are both “Philadelphia, USA”.

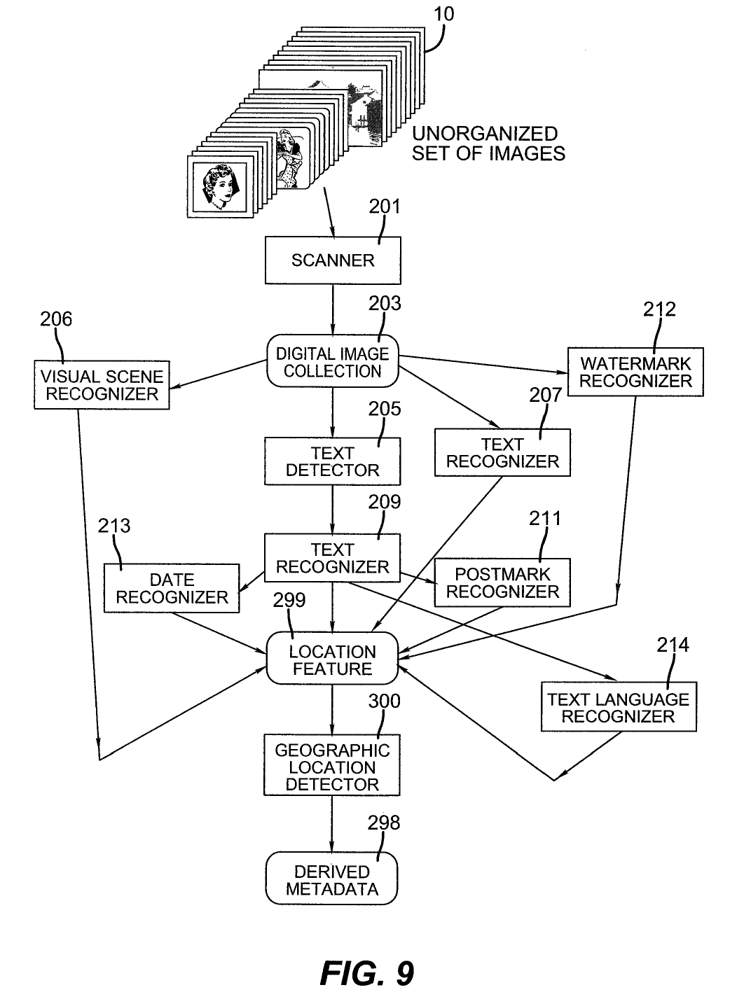

FIG. 3G shows an example of the information extracted from the image side 91 and the non-image side 100. In this particular embodiment, a text recognizer 209 extracts the information 1032 from the image and non-image sides, the visual scene recognizer 206 extracts the information 1030, the watermark recognizer extracts the information 1036, and the stamp recognizer extracts the information 1034. These individual components are discussed in detail with reference to FIG. 9 herein below.

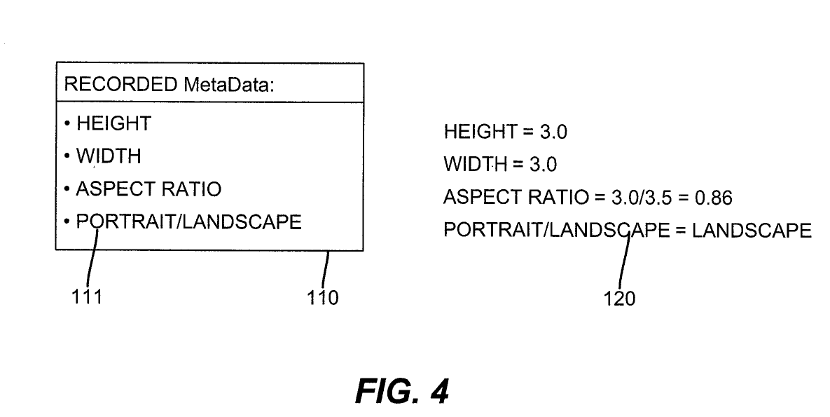

FIG. 4 illustrates recorded metadata 110 that is dynamically extracted from the hardcopy medium 90. The height, width, aspect ratio, and the orientation (portrait/landscape) for the hardcopy medium 90 can be extracted and recorded quickly and dynamically from the image and non-image surfaces of the hardcopy medium 90 without any derived calculations. The number of fields 111 correlating to the recorded metadata 110 can vary depending on, but not limited to, the characteristics of the hard copy medium 90, such as format, time period, photofinish, manufacturer, watermark, shape, size and other distinctive markings of the hardcopy medium 90. Accordingly, the recorded metadata 110 is dynamically acquired and subsequently stored in a dynamic digital metadata record. Sample values 120 for the recorded metadata fields 111 are shown adjacent to the recorded metadata 110.

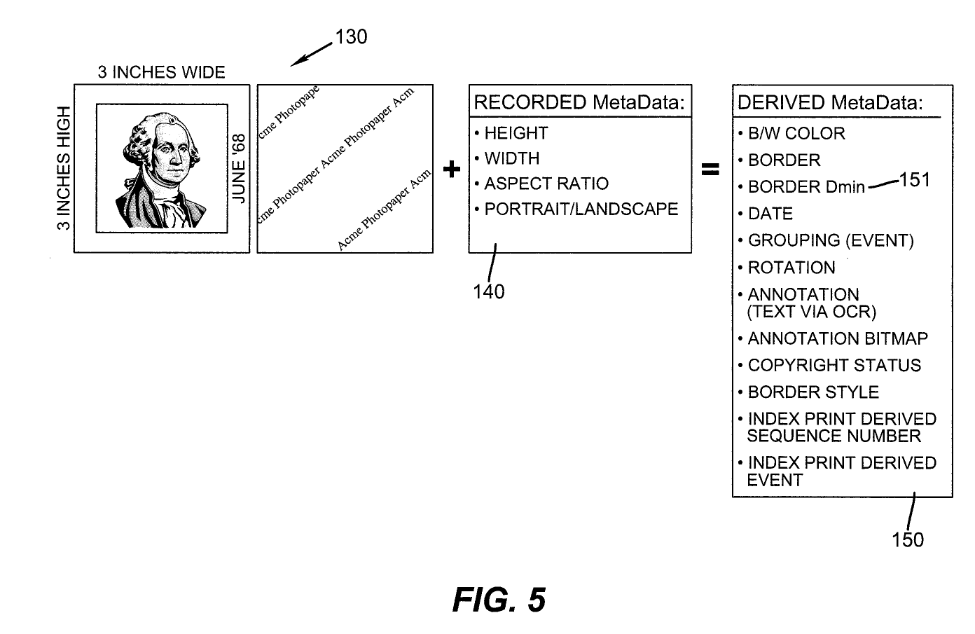

FIG. 5 is an illustration of metadata 150 dynamically derived from the combination of image and non-image surfaces and recorded metadata 140 of a hardcopy medium 130. The image and non-image surface of hardcopy medium 130 is analyzed using various methods and the resulting data is combined with the dynamically recorded metadata 140 to produce dynamically derived metadata 150. The derived metadata 150 requires several analysis algorithms to determine values for metadata fields 151 forming the dynamically derived metadata 150. The analysis algorithms include, but are not limited to, border detectors, black and white color detectors and orientation detectors. The number of metadata fields 151 correlating to the derived metadata 150 can vary depending on, but not limited to, the results of the algorithms, characteristics of the hard copy medium, as well as any additional information supplied by human or mechanical techniques as will be discussed in the following paragraphs. Accordingly, the derived metadata 150 is dynamically acquired and subsequently stored in a dynamic digital metadata record.

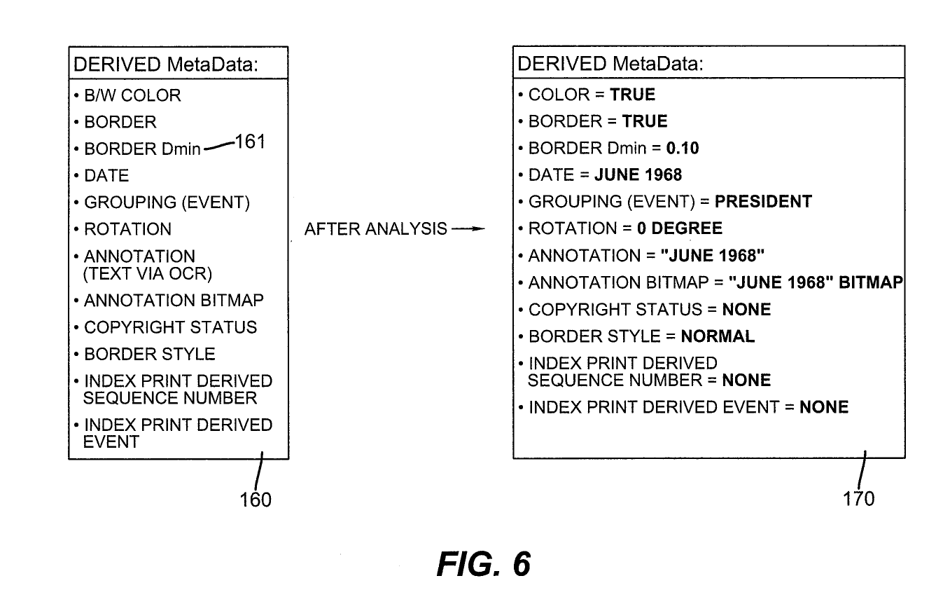

FIG. 6 is an illustration of sample values 170 for dynamically derived metadata 160. The derived metadata 160 includes sample values 161 for the color, border, border density, date, grouping, rotation, annotation, annotation bitmap, copyright status, border style, index print derived sequence, or index print derived event. However, the derived metadata 160 is not limited to these fields and any suitable fields can be dynamically created depending on at least the results of the algorithms, characteristics of the hard copy medium, as well as any additional information supplied by human or mechanical techniques, such as specific time era, subsequent pertinent information related to an event, correlated events, personal data, camera speeds, temperature, weather conditions, or geographical location.

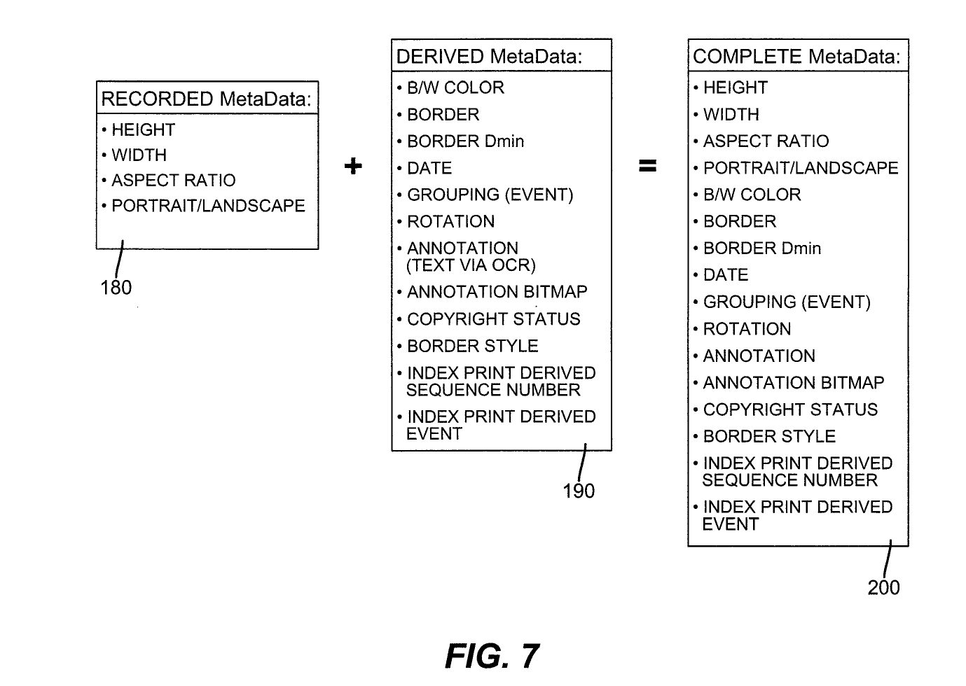

FIG. 7 is an illustration of the combination of dynamically recorded metadata 180 and dynamically derived metadata 190. This combination produces a complete metadata record, also referred to as dynamic digital metadata record 200, for the hardcopy medium. The complete metadata record 200, referred to as the dynamic digital metadata record, contains all information about a digitized hard copy medium. One or more complete metadata records 200 can be queried to at least group and correlate associated images given different search criteria.

For example, once every hardcopy medium item has been scanned and an associated complete metadata record 200 has been created, powerful search queries can be constructed to permit the hardcopy medium to be organized in different and creative ways. Accordingly, large volumes of hardcopy medium images can be rapidly converted into digital form and the digital metadata record 200 is dynamically created to completely represent the metadata of the image. This dynamic digital metadata record 200 can then be used for, but not limited to, manipulating the digitized hardcopy images, such as organizing, orientating, restoring, archiving, presenting and enhancing digitized hardcopy images.

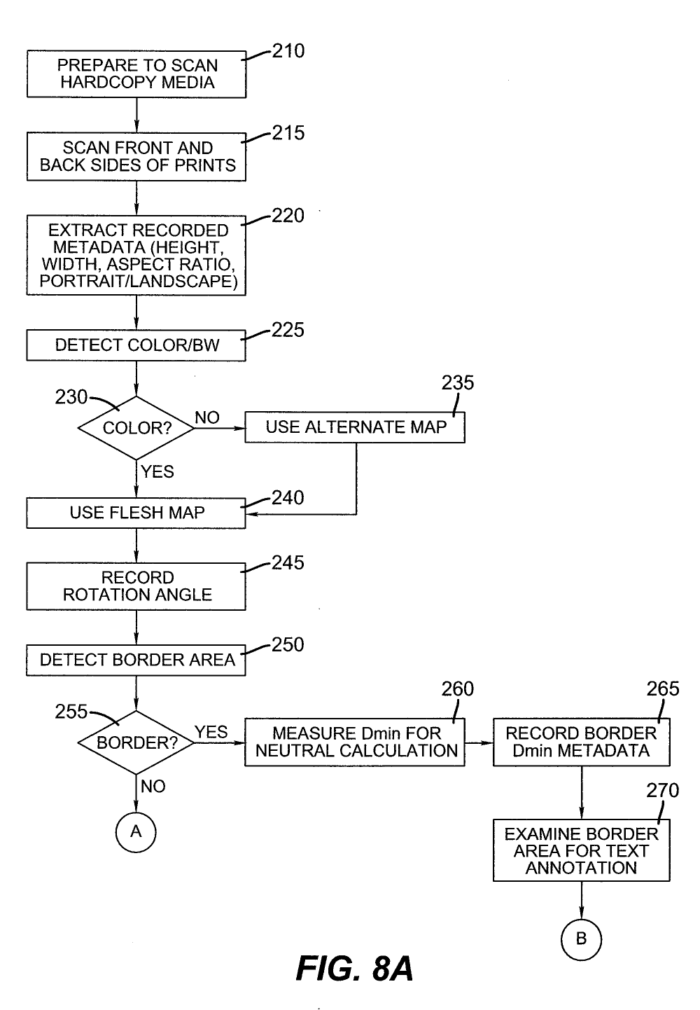

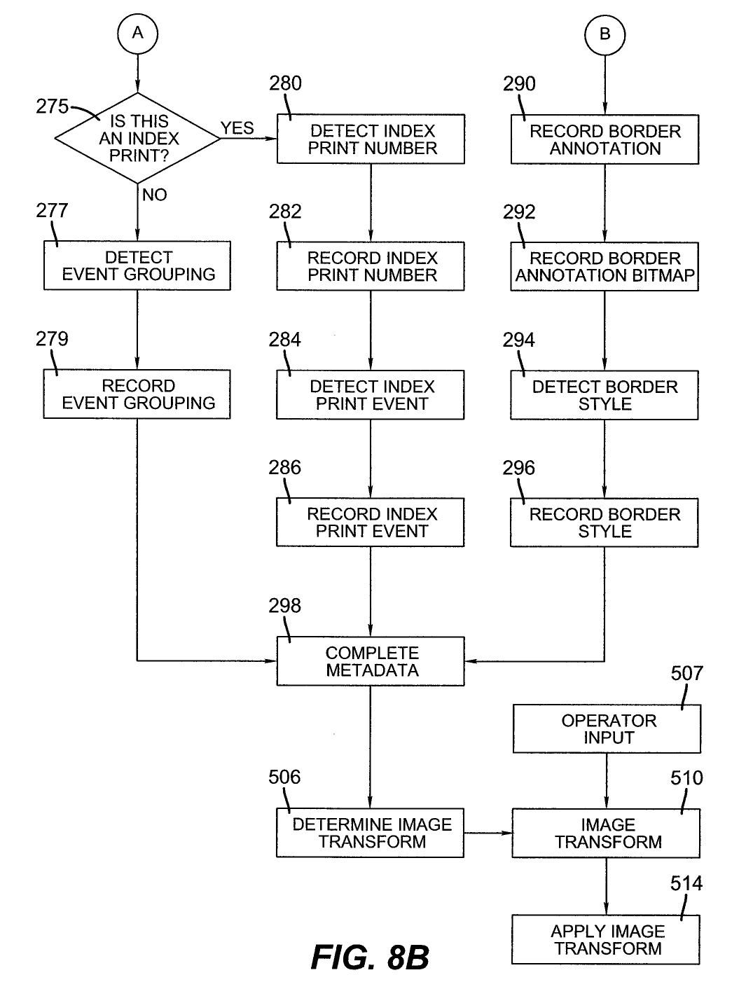

FIGS. 8A and 8B are flow charts illustrating the sequence of operation for creating the recorded, derived, and complete metadata representations. Hardcopy medium can include one or more of the following forms of input modalities: prints in photofinishing envelopes, prints in shoeboxes, prints in albums, and prints in frames. However, the embodiment is not limited to the above modalities, and other suitable modalities can be used.

Referring now to FIGS. 8A and 8B, a description of the operation of a system according to the present invention will now be described. FIGS. 8A and 8B are graphic depictions of a flowchart illustrating the sequence of operations for hardcopy image scanning and complete metadata creation. The hardcopy medium can include any or all of the following forms of input modalities, such as prints in photofinishing envelopes, prints in shoeboxes, prints in albums, and prints in frames.

The hardcopy medium can be scanned by a scanner in any order in which the medium was received. The medium is prepared 210 and the front and back of the medium is scanned 215. The scanner creates information in the image file that can be used to extract the recorded metadata information 220. By using a Color/Black and White algorithm 225, a decision point is created 230 and the appropriate color map (non-flesh, i.e. black and white) 235, (flesh color) 240 is used to find, but is not limited to, faces in the image. If the map is rotated in orientations of 0, 90, 180, 270 degrees with a face detector, the orientation of the image can be determined and the rotation angle (orientation) is recorded 245. The orientation will be used to automatically rotate the image before it is written (useful before writing to a CD/DVD or displaying one or more images on a display).

Using a border detector 250, a decision point is made if a border 255 is detected. If a border is detected, a minimum density (Dmin) 260 can be calculated by looking in the edge of the image near the border. After the border minimum density is calculated, it is recorded 265 in the derived metadata. Text information/annotation written in the border can be extracted 270. OCR can be used to convert the extracted text information to ASCII codes to facilitate searching. The border annotation is recorded 290 into the derived metadata. The border annotation bitmap can also be recorded 292 into the derived metadata. The border style such as scalloped, straight, rounded is detected 294 and recorded 296 into the derived metadata. If the image is an index print 275, information such as the index print number can be detected 280 and recorded 282. Index print events can also be detected 284 and recorded 286. If the image is not an index print 275, information such as a common event grouping can be detected 277 and recorded 279. The common event grouping is one or more images originating from the same event or a group of images having similar content. For example, a common event grouping can be one or more images originating from a fishing trip, birthday party or vacation for a single year or multiple years. The complete set of metadata In the present embodiment, the determine image transform step 506 uses derived metadata information 298 originally derived by scanning the non-image surface 100 of print medium 90 to determine an image transform 510. For example, the image transform 510 can be an image rotation such that the image is corrected in accordance with a determined image. An image transform 510 is applied to a particular image by the apply image transform step 514, producing an enhanced digital image.

The determine image transform step 506 can also use derived metadata 298 associated with other images from the same event grouping to determine the image transform 510. This is because an event grouping is detected 277 using watermarks 102 and recorded 279, as described above. In addition, the determine image transform 506 step can also use image information (i.e. pixel values) from the image and other image(s) from the same event grouping to determine the image transform 510. After application of the image transform, the improved rotated scanned digital image can be printed on any printer, or displayed on an output device, or transmitted to a remote location or over a computer network. Transmission can include placing the transformed image on a server accessible via the internet, or emailing the transformed image. Also, a human operator can supply operator input 507 to verify that the application of the image transform 510 provides a benefit. For example, the human operator views a preview of the image transform 510 applied to the image, and can decide to ‘cancel’ or ‘continue’ with the application of the image transform. Further, the human operator can override the image transform 510 by suggesting a new image transform (e.g. in the case of image orientation, the human operator indicates via operator input 507 a rotation of counter-clockwise, clockwise, or 180 degrees).

For example, the image transform 510 can be used to correct the orientation of an image based on the derived metadata associated with that image and the derived metadata associated with other imaged from the same event grouping. The image's orientation indicates which one of the image's four rectangular sides is “up”, from the photographer's point of view. An image having proper orientation is one that is displayed with the correct rectangular side “up”.

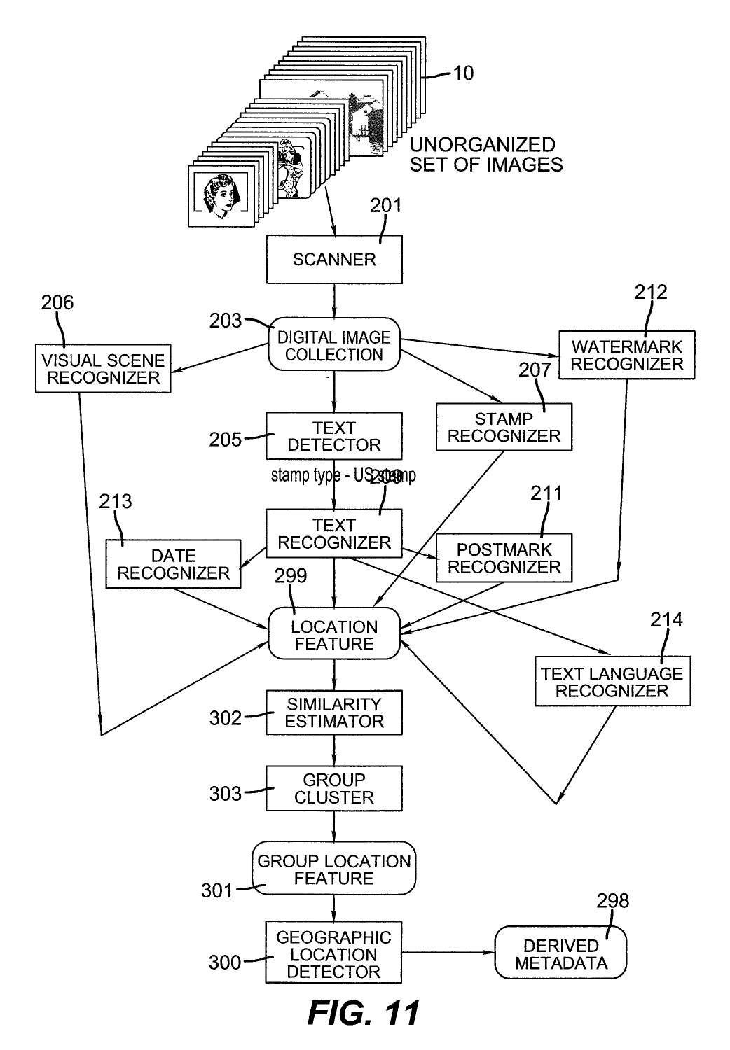

In FIG. 9, an inventive method for determining the geographic location of a scanned photographic print is illustrated. A geographic location of a hardcopy image is a guess at the location that the image represents. Geographic location is usually conveniently represented in terms of latitude and longitude coordinates. The geographic location can be a specific point on the globe (e.g. 43.205989 latitude, −77.628236 longitude). Geographic location for an image can also be represented as a probability distribution (either continuous or discrete) over a set or range of latitude and longitude coordinates. For example, an image of an object that appears to be the Statue of Liberty could be the one on Liberty Island in New York (40.689321 latitude, −74.044645 longitude) with 90% likelihood, or could be one of the replicas in France (e.g. 48°51 ′0″ N 2°16′47″ E/48.85, 2.27972), with 10% likelihood. Geographic location can also be expressed over political boundaries (e.g. 10% likelihood that the image is captured in France, 80% likelihood the image is captured in Quebec, Canada and 10% likelihood the image is captured in New Orleans) or physical addresses or postal codes. The geographic location for an image can be expressed as a mixture of Gaussian distributions over the globe, each centered at a particular location with a particular covariance over latitude and longitude. Furthermore, the geographic location for an image can be expressed as a mixture of von Mises-Fisher distributions over the globe. A geographic location can be assigned individually for each hardcopy image or for groups of images. When groups are considered, images in the same group share a common location feature and consequently are assigned the same geographic location. The formation of groups will be described in FIGS. 11 and 12.

The geographic location of a hardcopy image is detected with the help of a location feature. A location feature 299 is any information extracted by one or more of a suite of recognizers (a text recognizer 209, a text language recognizer 214, a date recognizer 213, a postmark recognizer 211, a stamp recognizer 207, and a watermark recognizer 212) which operate upon the image and the non-image surfaces of a hardcopy image such that the information is useful in detecting the geographic location of an image. Some examples of a location feature are the format of the printed or handwritten date, the language of the handwritten or printed text, or location specific words extracted from one or more of the aforementioned recognizers. A location specific word is a word in any language which can be directly converted into geographic location(s) using available geographical knowledgebases. A location specific word can be as precise as “Paris, France” or as generic as “beach”. Location specific words specify the geographic location as a distribution over the entire world. The aforementioned recognizers and the location feature(s) which they produce will be described in detail below.

A collection of hardcopy medium 10 is scanned by a scanner 201. Preferably, the scanner 201 scans both the image side (producing a scanned digital image) and the non-image side of each photographic print. The collection of these scans make up a digital image collection 203.

A text detector 205 is used to detect text on either the scanned digital image or the scan of the non-image side of each image. For example, text can be found with the method described by U.S. Pat. No. 7,177,472. In the present invention, there are two types of text that are of primary interest: handwritten annotations and machine annotations.

Handwritten annotations contain rich information, often describing the location of the photo, the people in the photo and the date of the photo. Recognizing handwritten text, of course poses challenges due to large variations in handwritings, language, and grammar of the handwritten text. There have been several attempts in the machine learning community to address the problem of handwritten character recognition. The published article of R Plamondon, S N Srihari, E Polytech, Q Montreal, Online and off-line handwriting recognition: a comprehensive survey, IEEE Trans. Pattern Analysis and Machine Intelligence, 2000 discusses this field in detail. This problem is more generally covered in the field of OCR, Optical Character Recognition which refers to the process of mechanical or electronic translation of images of handwritten, typewritten or printed text from a scanned print into machine-editable text. Examples of handwritten and printed text are shown as 1000 and 1006 respectively in FIG. 3E. In these examples, the handwritten text is “Philadelphia, USA” and the printed text is an address “James Bond 21 Chestnut Street, #3 Philadelphia, Pa., USA” to which the photograph was mailed. The printed or handwritten text can form a part-of or complete location feature 299 and passed to a geographic location detector 300.

A date recognizer 213 analyzes the recognized text from a text recognizer 209. Text recognizer 209 is an OCR system. The recognized text is analyzed by the date recognizer 213 that searches the text for possible dates, or for features that relate to a date. Note that the image capture date can be precise (e.g. Jun. 26, 2002 at 19:15) or imprecise (e.g. December 2005 or 1975 or the 1960s), or can by represented as a continuous or discrete probability distribution function over time intervals. Features from the image itself give clues related to the date of the image. Additionally, features describing the actual photographic print (e.g. black and white and scalloped edges) are used to determine the date. Finally, annotations can be used to determine the date of the photographic print as well. When multiple features are found, a Bayesian network or another probabilistic model is used to arbitrate and determine the most likely date of the photographic print.

For determining the geographic location, the exact date is not as valuable as the format in which date has been written. There are three standard ways to express calendar dates in popular as well as formal use:
(i) dd/mm/yy or dd/mm/yyyy—used in certain European and South American countries, and in India,
(ii) mm/dd/yy or mm/dd/yyyy—used in USA and parts of Canada, and
(iii) yy/mm/dd or yyyy/mm/dd—used mainly in China, Korea and certain other Asian countries.

A complete list of calendar date formats and their usages can be obtained from any encyclopedia (for example Wikipedia http://en.wikipedia.org/wiki/Calendar_date). The format of writing the date (handwritten or printed date) can be a useful cue to determine where the picture was taken. It is possible that the format of the date alone may not be sufficient to determine the geographic region precisely. Ambiguities could result from errors in identifying the date, months, and year fields in a date represented in any of the aforementioned formats. However, the date format feature used in conjunction with other forms of inferences (for example determining date using front scans only) can be helpful in reducing ambiguities. Another possibility is that the handwritten or printed date could represent the geographic affiliation of the writer, photographer, or her place of residence rather than the geographic affiliation of the picture itself. The calendar date or the format of the calendar date can form a part-of or complete location feature 299 and passed to the geographic location detector 300.

A postmark recognizer 211 analyzes the recognized text from the text recognizer 209. A postmark is a postal marking made on a letter, package, postcard or a back of a photo indicating the date, time, and place that the item was delivered into the care of the postal service. Postmarks may be applied by hand or by machines, using methods such as rollers or inkjets, while digital postmarks are a recent innovation. Postmarks are found on the back of photographs if they were mailed. An example postmark is shown as 1002 in FIG. 3C. Postmarks are useful as they can give direct evidence about the geographic location of the postal service. For example, postmark 1002 in FIG. 3C indicates USA as the location where the photograph was mailed from. The text obtained from the postmark can form a part-of or complete location feature 299 and passed to the geographic location detector 300.

A text language recognizer 214 analyzes the recognized text from the text recognizer 209. The preprinted or handwritten text can correspond to one or more languages. For example, the text can be written in English and German. The language(s) of the text can be converted to one or more location specific word(s). A method to detect the language of text can be found in U.S. Patent Application Publication No. 2002/0095288, Text language detection. The language of the preprinted or handwritten text or the location specific word(s) obtained from the language of the text can form a part-of or complete location feature 299 and passed to the geographic location detector 300.

A stamp recognizer 207 analyses the collection 203. A postage stamp is an adhesive paper evidence of pre-paying a fee for postal services. Usually a small paper rectangle or square that is attached to the object being mailed, the postage stamp signifies that the person sending the letter or package may have either fully, or perhaps partly, pre-paid for delivery. An example postage stamp is shown as 1004 in FIG. 3C. Postage stamps can be strong indicators of the geographic location of photographs. Every country has its own representative postage stamps spanning over different periods of time. This information can be easily acquired from an encyclopedia and stored in a knowledgebase. An ideal embodiment of the stamp recognizer 207 extracts visual signatures from a stamp such as 1004 and compares it with visual signatures of known stamps in the knowledgebase to obtain one or more location specific words which help to make a decision on the geographic affiliation of the stamp. A method to compare images using visual signatures has been studied in the published article of J. Z. Wang, J. Li, and G. Wiederhold, SIMPLIcity: Semantics-Sensitive Integrated Matching for Picture Libraries, IEEE Trans. on Pattern Analysis and Machine Intelligence, 2001. The stamp or the location specific word(s) associated with the stamp can form a part-of or complete location feature 299 and passed to the geographic location detector 300.

A watermark recognizer 212 analyses the collection 203. An example of a manufacturer watermark is shown as 102 in FIG. 3A. As discussed earlier, watermarks are used for promotional activities such as advertising manufacturer sponsorships, to designate special photofinishing processes and services, and to incorporate market specific characteristics such as foreign language translations for sale in foreign markets. Recognizing a watermark can be helpful in identifying the geographic affiliation of the manufacturer. Information about watermarks and their respective manufacturers spanning over different periods of time can be obtained from a watermark directory and stored in a knowledgebase. An ideal embodiment of the watermark recognizer 212 extracts visual signatures from a watermark such as 102 and compares it with visual signatures of known watermarks to obtain one or more location specific words which help make a decision on the manufacturer or geographic location of the watermark. A method to compare images using visual signatures has been studied in the published article of J. Z. Wang, J. Li, and G. Wiederhold, SIMPLIcity: Semantics-Sensitive Integrated Matching for Picture Libraries, IEEE Trans. on Pattern Analysis and Machine Intelligence, 2001. The watermark or the location specific word(s) associated with the watermark can form a part-of or complete location feature 299 and passed to the geographic location detector 300.

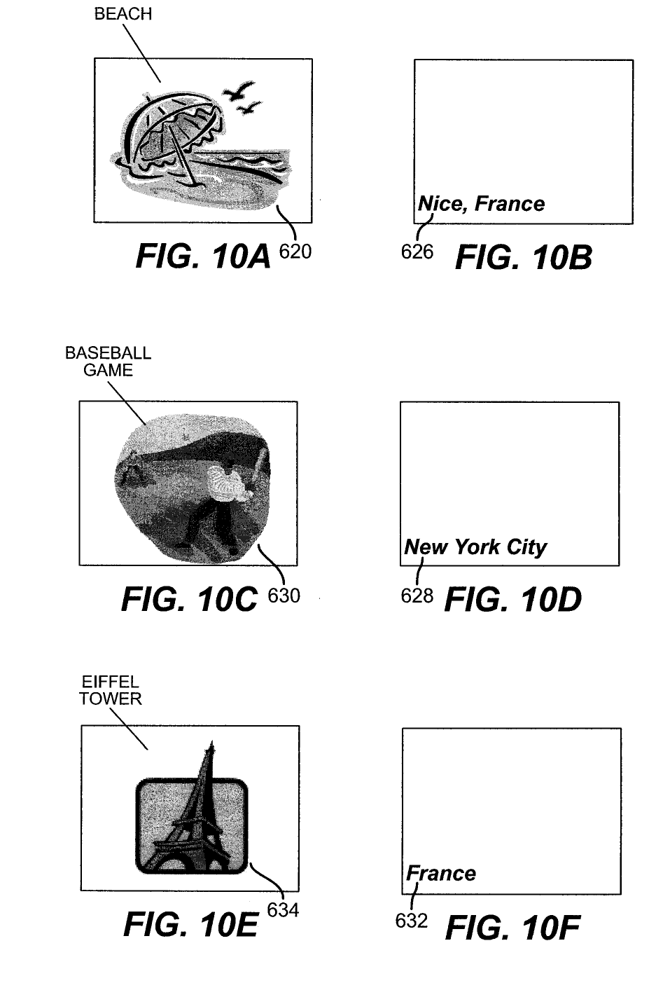

A visual scene recognizer 206 analyses the collection 203. Visual scene recognition has been studied in the computer vision research area for a number of years. Scene recognition can range from recognizing activities/events in an image to pinpointing to exact place where the image was taken. Scene recognition can be helpful for refining the geographic location in association with other forms of inferences. For example, if the text recognizer 209 detects the text “Nice, France” (626 in FIG. 10B), and the scene recognizer detects a “beach” (620 in FIG. 10A), then the geographic location can be even further refined to the beaches in Nice, France. In yet another example, the text recognizer 209 detects the text “New York City” (628 in FIG. 10D), and the scene recognizer detects a “baseball game” (630 in FIG. 10C), and the two inferences can be used to refine the geographic location to all the baseball stadiums in New York City. The published article of M. R. Boutell, J. Luo, X. Shen, and C. M. Brown, Learning multi-label scene classification, Patten Recognition, 2004 discusses a method to perform scene recognition. The published article of J. Hays, and A. Efros, IM2GPS: estimating geographic information from a single image, In Proc. IEEE Int. Conf. on Computer Vision and Pattern Recognition, 2007 describes a method to geographically locate an image using visual features. In an embodiment of the current patent, the technique described in the aforementioned article can be used to recognize “Eiffel tower” (634 in FIG. 10E) using only the front scan of the image. Any additional information such as the text “France” (632 in FIG. 10F) is used to complement that inference. In the current invention, the visual scene recognizer 206 can output one or more location specific words. The location specific word(s) associated with the visual scene can form a part-of or complete location feature 299 and passed to the geographic location detector 300. The geographic location obtained from the geographic location detector 300 forms a part-of or complete derived metadata 298.

FIG. 11 is the flow chart illustrating the method of grouping scanned images believed to have been captured in a similar geographic location. A similarity estimator 302 uses the output from the suite of recognizers (text recognizer 209, text language recognizer 214, date recognizer 213, postmark recognizer 211, stamp recognizer 207, and watermark recognizer 212) and the location feature(s) 299 which have been described in FIG. 9 to estimate the pairwise similarities between images. Classic distance metrics including Euclidean distance, Manhattan distance, or Mahalanobis distance can be used in 302. Advanced learning-based distance measures can provide more accurate similarity estimation here at the cost of computational complexity, such as Yu et al's method in “Distance Learning for Similarity Estimation”, IEEE Trans. Pattern Analysis and Machine Intelligence, 2007 or Yang et al's method in “An efficient algorithm for local distance metric learning”, Proc. of Conf. of Association for the Advancement of Artificial Intelligence, 2006. The estimated similarity values are provided as input to group cluster 303 that assigns images to multiple groups. In an embodiment of the current invention the K-means algorithm of Hartigan and Wong, “A K-means clustering algorithm”, Applied Statistics, 1979 can be used to perform the clustering. Group location features 301 are constructed by combining or pooling the location features 299 of all the images in the same groups. As a result, images in the same group are assigned the same geographic location obtained from the geographic location detector 300 which further form a part-of or complete derived metadata 298. Those skilled in the art will recognize that groups of images can also be defined by features other than those shown in FIG. 11, for example a group of images is the set of all hardcopy media in a particular physical envelope or container. The important aspect of FIG. 11 is that images are grouped 303 into a group believed to have been captured in a similar geographic location. Then, a location feature 301 for the entire group is found. For example, the group location feature 301 contains the features extracted from postage stamps from all the images in the group. Then the group location feature 301 is used to determine a geographic location fro the group of images, which is stored in association with the images as metadata 298.

The invention has been described in detail with particular reference to certain preferred embodiments thereof, but it will be understood that variations and modifications can be effected within the spirit and scope of the invention.

### PARTS LIST

10 Hardcopy medium
20 1^{st} subgroup images of bordered 3.5″×3.5″ prints
30 2^{nd} subgroup images of borderless 3.5″×5″ prints with round corners
40 3^{rd} subgroup images of bordered 3.5″×5″ prints
50 4^{th} subgroup images of borderless 4″×6″ prints
60 Picture book
70 Picture CD
80 Magnetic storage of images (online gallery)
90 Photographic print medium
91 Image surface
92 Date designation
94 Border
96 Image data
100 Non-image surface
102 Watermark
110 Recorded metadata
111 Recorded metadata fields
120 Sample values
130 Hardcopy medium
140 Recorded metadata
150 Derived metadata
151 Metadata fields
160 Derived metadata
161 Sample values
170 Derived metadata from scanned image with sample data
180 Recorded metadata
190 Derived metadata
200 Digital metadata record
201 Scanner
203 Digital image collection
205 Text detector
206 Visual scene recognizer
207 Stamp recognizer
209 Text recognizer
210 Prepared medium
211 Postmark recognizer
212 Watermark recognizer
213 Date recognizer
214 Text language recognizer
215 Scanned medium/prints
220 Extracted recorded metadata
225 Color or black and white algorithm
230 Decision point
235 Black and white color map
240 Flesh color map
245 Recorded rotation angle
250 Border detector
255 Border
260 Measure the Dmin (minimum density) for the neutral color calculation
265 Recorded border minimum density
270 Extracted text information/annotation
275 Index print
277 Detect like events (pictures taken at the same event)
279 Record the event in the metadata record
280 Detected index print
282 Recorded index print
284 Detected index print events
286 Recorded index print events
290 Recorded border annotation
292 Record the border annotation bitmap in the metadata record
294 Detected border style
296 Recorded border style
298 Derived metadata record
299 Location feature
300 Geographic location detector
301 Group location feature
302 Similarity estimator
303 Group cluster
506 Determine image transform
507 Operator input
510 Image transform
514 Apply image transform
620 Image surface of a beach image
626 Text on non-image surface of a beach image
628 Text on non-image surface of a baseball game image
630 Image surface of a baseball game image
632 Text on non-image surface of an Eiffel tower image
634 Image surface of an Eiffel tower image
1000 Handwritten text on non-image surface
1002 Postmark label on non-image surface
1004 Stamp on non-image surface
1006 Printed address on non-image surface
1010 Handwritten text on image surface
1030 Information extracted with visual scene recognizer
1032 Information extracted with text recognizer
1036 Information extracted with watermark recognizer
1034 Information extracted with stamp recognizer

1. A method of determining the geographic location of a hardcopy medium having an image side and a non-image side, comprising:
(a) scanning a hardcopy medium to produce a scanned digital image;
(b) scanning the non-image side of the hardcopy medium;
(c) detecting a location feature from the scan of the non-image side of the hardcopy medium;
(d) using the location feature to determine the geographic location of the scanned digital image; and
(e) storing the determined geographic location of the scanned digital image.

2. The method of claim 1, wherein the location feature contains a postmark, a postage stamp, a watermark or a combination thereof.

3. The method of claim 1, wherein the location feature is extracted from the preprinted or handwritten text from the scan of the non-image side of the hardcopy medium.

4. The method of claim 3, wherein the location feature is the language of the preprinted or handwritten text extracted from the scan of the non-image side of the hardcopy medium.

5. The method of claim 3, wherein the preprinted or handwritten text is a date and the location feature is the format of the date.

6. The method of claim 2, wherein the location feature further includes features extracted from the preprinted or handwritten text from the scan of the non-image side of the hardcopy medium.

7. The method of claim 1, wherein the location feature further includes features extracted from the scan of the image side of the hardcopy medium.

8. The method of claim 7, wherein the location feature further includes postmark, a postage stamp, a watermark, preprinted or handwritten text from the scan of the non-image side of the hardcopy medium, or combinations thereof.

9. The method of claim 7, wherein the image content from the image side of the hardcopy medium is the visual scene type.

10. The method of claim 6, wherein the preprinted or handwritten text from the scan of the non-image side of the hardcopy medium is analyzed to detect location specific words.

11. A method of determining the geographic location of a hardcopy medium having an image side and a non-image side, comprising:
(a) scanning a hardcopy medium to produce a scanned digital image;
(b) producing a location feature by detecting preprinted or handwritten text from the scanned digital image;
(c) using the location feature to determine the geographic location of the scanned digital image; and
(d) storing the determined geographic location of the scanned digital image.

12. The method of claim 11, wherein the location feature is a postmark, a postage stamp, a watermark or a combination thereof.

13. The method of claim 11, wherein the location feature is extracted from the preprinted or handwritten text from the scanned digital image.

14. The method of claim 13, wherein the location feature is the language of the preprinted or handwritten text extracted from the scanned digital image.

15. The method of claim 13, wherein the preprinted or handwritten text is a date and the location feature is the format of the date.

16. The method of claim 12, wherein the location feature further includes features extracted from the preprinted or handwritten text.

17. The method of claim 11, wherein the location feature further includes features extracted from the image region of the scanned digital image.

18. The method of claim 17, wherein the location feature further includes postmark, postage stamp, preprinted or handwritten text from the scanned digital image, or combinations thereof.

19. The method of claim 16, wherein the preprinted or handwritten text from the scanned digital image is analyzed to detect location specific words.

20. A method of determining geographic locations of a collection of hardcopy media each having an image side and a non-image side, comprising:
(a) scanning the hardcopy media to produce a collection of scanned digital images;
(b) grouping a set of similar scanned digital images to produce a group of scanned digital images believed to have been captured in a similar geographic location;
(c) producing a location feature for the group of scanned digital images;
(d) using the location feature to determine the geographic location of the group of scanned digital images; and
(e) storing the determined geographic location of the group of scanned digital images.

21. The method of claim 20, wherein the group of scanned digital images is produced by p1 (b1) extracting grouping features from each scanned digital image in the collection wherein the grouping features include image appearance features, postmark, postage stamp, watermark, preprinted or handwritten text from the scanned digital image, or combinations thereof,
(b2) computing the similarity between pairs of scanned digital images based on their associated grouping features; and
(b3) producing a group of scanned digital images based on the similarities between pairs of scanned digital images.

22. The method of claim 20, wherein the location feature for the group of scanned digital images includes the visual scene type(s), postmark(s), postage stamp(s), watermark(s), preprinted or handwritten text from the group of scanned digital images, or combinations thereof.
